(19) United States
(12) Patent Application Publication
(10) Pub. No.: US 2011/0217476 A1
(43) Pub. Date: Sep. 8, 2011

(54) CONVERSION LAYERS FOR SURFACES CONTAINING ZINC

(76) Inventors: Björn Dingwerth, Berlin (DE); Andreas Noack, Berlin (DE)

(21) Appl. No.: 13/125,357

(22) PCT Filed: Nov. 23, 2009
(86) PCT No.: PCT/EP2009/065646

§ 371 Date: Apr. 21, 2011

(30) Foreign Application Priority Data
Nov. 27, 2008 (DE) 10 2008 044 143.0

(51) Int. Cl. B05D 1/18

(52) U.S. Cl. 427/436

(57) ABSTRACT

The invention relates to a process for producing a coating layer which protects against corrosion, in which a surface to be treated is brought into contact with an aqueous treatment solution containing at least one source of chromium(III) ions and also at least one organic compound which oxidizes zinc in weakly acidic or acidic solution. Here, the decorative and functional properties of the surface are retained or improved. In addition, the known problems associated with the use of chromium(VI)-containing compounds are avoided.

### FIELD OF THE INVENTION

The invention relates to corrosion protection of metallic materials, in particular materials which are provided with a conversion layer.

### BACKGROUND OF THE INVENTION

To protect the surfaces of metallic materials against corrosive environmental influences, the prior art provides various methods. Coating of the metallic workpiece to be protected with a coating of another metal is a widespread and established method in the prior art. The coating metal can be either electrochemically more noble or less noble in the corroding medium than the substrate metal of the workpiece alone. If the coating metal is less noble, it functions as sacrificial anode relative to the substrate metal in the sense of cathodic corrosion protection in the corroding medium. Although this protective function associated with the formation of corrosion products of the coating metal is thus desirable, the corrosion products of the coating themselves often lead to undesirable decorative and not uncommonly also to functional adverse effects on the workpiece. To reduce corrosion of the coating metal or to delay it as long as possible, conversion layers are frequently used, especially on cathodically protecting non-noble coating metals such as zinc or alloys thereof. These conversion layers are reaction products of the non-noble coating metal with the reaction solution which are insoluble in aqueous media within a wide pH range. Examples of these conversion layers are, for example, phosphating and chromating layers. In the case of phosphating layers, the layer to be protected is dipped into an acidic solution containing phosphate ions. The acidic medium leads to partial dissolution of zinc from the coating. In principle, the liberated Zn²⁺ cations react with the phosphate ions of the reaction solution to form a sparingly soluble zinc phosphate layer on the surface. Since zinc phosphate layers themselves provide only comparatively poor corrosion protection but are an excellent primer for paints and varnishes applied thereto, their main function in applications is as base for paints and varnishes.

In the case of chromating layers, the surface to be treated is dipped into an acidic solution containing chromium(VI) ions. If the surface is, for example, a zinc surface, part of the zinc dissolves. Under the reducing conditions prevailing here, chromium(VI) is reduced to chromium(III) which in the surface film which has become more alkaline due to evolution of hydrogen is deposited, inter alia, as chromium(III) hydroxide or as a sparingly soluble μ-oxo- or μ-hydroxo-bridged chromium(III) complex. In parallel, sparingly soluble zinc chromate(VI) is formed. The overall result is formation of an impermeable conversion coating on the zinc surface which provides very good protection against corrosive attack by electrolytes.

Chromium(VI) compounds have not only acute toxicity but also a high carcinogenic potential, so that a replacement for the processes employing these compounds is necessary. A number of processes using various complexes of trivalent chromium compounds have now become established as a replacement for chromating processes using hexavalent chromium compounds. A critical step during the course of the deposition is a reaction as a result of which the pH on the interface of the zinc surface or zinc-containing surface with the solution increases to such an extent that deposition of the conversion layer occurs.

Chromium(III) is not suitable in the above-described sense as oxidant for zinc. Although reduction to chromium(II) is possible on the basis of the redox potentials, this does not lead to an increase in the pH at the interface. It is therefore necessary, in order to build up a conversion layer from an aqueous acidic solution of chromium(III) ions, to also add a suitable oxidant which increases the concentration of zinc ions and also the pH at the interface between zinc or zinc alloy and solution to such an extent that the components of the conversion layer which are soluble at the pH in the interior of the solution are converted on the metal surface into a sparingly soluble hydrolysis form.

In order to obtain chromium(VI)-free treatment solutions, peroxides such as hydrogen peroxide or peroxodisulfates have been proposed as oxidant (U.S. Pat. No. 4,384,902, U.S. Pat. No. 4,349,392). At the acidic pH values, hydrogen peroxide is not a sufficiently strong oxidant to oxidize chromium(III) to chromium(VI).

Nitrate has found wide use as oxidant which oxidizes zinc; it contributes to an increase in the pH and does not oxidize chromium(III) under the conditions of the treatment solutions (EP 0 907 762 B1, EP 1 318 214 A1, WO 2004/072325 A1).

Under the usual reaction conditions of the treatment solutions, nitrate is firstly reduced to nitrite

NO₃⁻+Zn+2H₃O⁺⇄NO₂⁻+Zn²⁺+3H₂O

and the nitrite formed in this way acts as more active oxidant to effect further oxidation in accordance with

2NO₂⁻+4H₃O⁺+Zn⇄2NO↑+6H₂O+Zn²⁺

to form nitrogen monoxide.

2NO₃⁻+3Zn+8H₃O⁺⇄2 NO↑+3 Zn²⁺+12H₂O

Furthermore, in the acid medium of the treatment solutions whose pH is usually in the range from pH 1 to pH 3.5, nitrite is not stable but tends to disproportionate into nitrate and nitrogen monoxide:

3NO₂⁻+2H₃O⁺⇄NO₃⁻+2 NO↑+3H₂O

Both the reduction of nitrite and the disproportionation of nitrite in the acidic solution thus lead to liberation of nitrogen monoxide. Nitrogen oxides are toxic gases and it is absolutely essential to extract them from above the solution surface.

EP 1 816 234 A1 describes an aqueous reaction solution and a process for passivating zinc and zinc alloys. The reaction solutions contain nicotinic acid, salts thereof or derivatives thereof. Colored passivation layers are produced on zinc and zinc alloys from such reaction solutions. Nicotinic acid is not suitable as oxidant in chromium(III)-containing treatment solutions for producing conversion layers on zinc-containing surfaces.

EP 1 970 470 A1 describes chromium(VI)-free black passivation layers for zinc-containing surfaces, which can contain carboxylic acid derivatives of pyridine as complexing agents. Such carboxylic acid derivatives of pyridine cannot act as oxidant in such solutions.

EP 1 005 578 B1 and GB 715,607 describe processes for producing phosphating layers. Organic nitro compounds and organic N-oxides are employed here as accelerators. The phosphating layers described here are porous and therefore do not provide corrosion protection.

### DESCRIPTION OF THE INVENTION

It is an object of the present invention to provide an oxidant which meets the abovementioned criteria in respect of zinc oxidation, oxonium ion consumption and reactivity towards chromium(III) but does not lead to formation of toxic gases. These criteria are satisfied by the organic oxidants of the invention selected from among aliphatic nitro compounds, aromatic nitro compounds, N-oxides and quinones. The replacement of nitrates by water-soluble, organic oxidants does not lead to gaseous, toxic reaction products.

Nitrate ions can be present in a low concentration in the solution without the negative properties becoming a problem. However, the solution preferably does not contain any nitrate.

This object is achieved by an aqueous treatment solution for producing essentially chromium(VI)-free black conversion layers on zinc or zinc alloy layers, which solution contains, inter alia, the following components:
at least one source of Cr³⁺ ions and
at least one organic compound selected from the group comprising

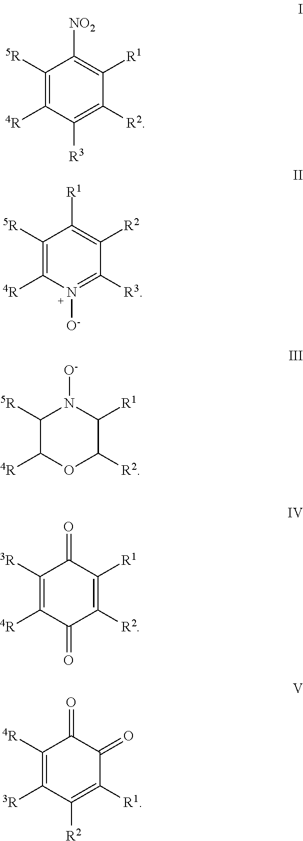

where R¹ to R⁵ are each, independently of one another,
a) a hydrogen atom or an alkyl group which has from 1 to 10 carbon atoms and may be linear or branched or
b) an —NR₂, —NO₂, —COOR, —OR, —SO₃R group where R═—H or an alkyl group which has from 1 to 5 carbon atoms and may be linear or branched, with methyl, ethyl, n-propyl and isopropyl being particularly preferred,
   with the proviso that from 0 to 2 radicals R¹ to R⁵ are selected from group b).

Preferred organic compounds are selected from the group consisting of compounds of the formulae I., III., IV. and V., where R¹ to R⁵ are each, independently of one another,
a) a hydrogen atom or an alkyl group which has from 1 to 10 carbon atoms and may be linear or branched
b) an —NR₂, —NO₂, —COOR, —OR, —SO₃R group where R═—H or an alkyl group which has from 1 to 5 carbon atoms and may be linear or branched, with methyl, ethyl, n-propyl and isopropyl being particularly preferred,
   with the proviso that from 0 to 2 radicals R¹ to R⁵ are selected from group b).

Particularly preferred organic compounds are selected from the group consisting of compounds of the formula I., where R¹ to R⁵ are each, independently of one another,
a) a hydrogen atom or an alkyl group which has from 1 to 10 carbon atoms and may be linear or branched or
b) an —NR₂, —NO₂, —COOR, —OR, —SO₃R group where R═—H or an alkyl group which has from 1 to 5 carbon atoms and may be linear or branched, with methyl, ethyl, n-propyl and isopropyl being particularly preferred,
   with the proviso that from 0 to 2 radicals R¹ to R⁵ are selected from group b).

Examples of suitable classes of compounds are, for example, nitrobenzoic acids, nitrosalicylic acids, nitrophenols, dinitrophenols, trinitrophenols, nitropropionic acid, pyridine N-oxides, morpholine N-oxides and also benzoquinones. Suitable compounds for the purposes of the invention are therefore, for example, m-nitrobenzoic acid, 2-hydroxy-5-nitrobenzoic acid, 3,5-dinitrosalicylic acid, 2,4-dinitrophenol, m-nitrobenzenesulfonic acid, N-methylmorpholine-N-oxide, pyridine N-oxide and p-benzoquinone.

Furthermore, it has surprisingly been found that when using organic oxidants such as quinones, N-oxides and aromatic nitro compounds such as nitrobenzoic acids, nitrophenols, in particular nitrobenzenesulfonic acids such as m-nitrobenzenesulfonic acid, the corrosion protection of the conversion layers produced is significantly above that which can be achieved by corresponding nitrate-containing passivation layers. This applies in particular to conversion layers which have been pigmented black or dark by incorporation of metal particles of iron, cobalt or nickel or particles of black or blackening metal compounds of the metals mentioned.

It is highly probable that this is attributable not only to other kinetics of the oxidation of zinc and thus growth of the conversion layer but also to corrosion-inhibiting properties of the reduction products of the organic oxidants which have been deposited or adsorbed in the passivation layer and are in turn good reducing agents. Examples of possible reduction reactions are shown in equation 1.

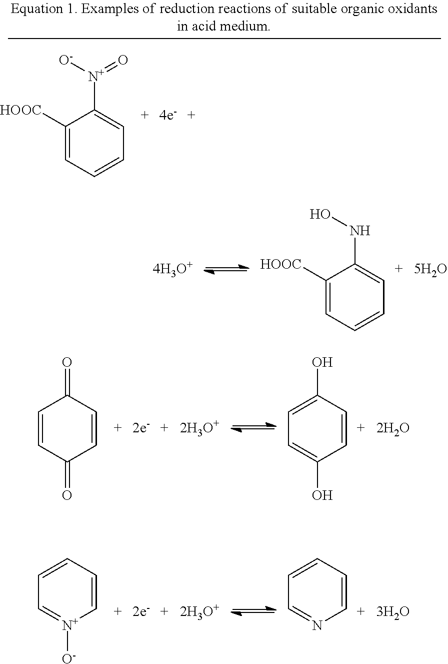

A further advantage of the components according to the invention is that they do not have any free nitrate and can thus be used in solutions for producing conversion layers which contain dyes having amino groups. The disadvantage of the use of nitrate ions as is known in the prior art for producing the conversion layer is that the nitrate is reduced to nitrite. In the strongly acid solution for formation of the conversion layer, this nitrite can enter into diazotization reactions with amino-containing dyes, leading to undefined dye products which no longer give the desired surface color of the conversion layer. Organically bound NO groups as per the formulae I.-III. do not undergo such reactions.

Aqueous treatment solutions according to the invention contain from 0.2 g/l to 20 g/l of chromium(III), preferably from 0.5 g/l to 15 g/l of chromium(III) ions and particularly preferably from 1 g/l to 5 g/l of chromium(III) ions. No Cr(VI) salts are added to the solution. Anions present can be, for example, methanesulfonate, sulfate, hydrogensulfate, borates and also the anions of acidic boron esters, phosphate, hydrogenphosphate, dihydrogenphosphate, nitrate, nitrite, chloride, iodide, fluoride, hexafluoro-silicate, hexafluorotitanate, tetrafluoroborate, hexafluoroantimonate, hexafluorophosphate, phosphate, hydrogenphosphate, dihydrogenphosphate and appropriate anions of esters of phosphoric acid. Chromium(III) can be added to the solutions either in the form of a chromium(III) salt such as basic chromium(III) sulfate, chromium(III) hydroxide, chromium(III) dihydrogen-phosphate, chromium(III) chloride, potassium chromium(III) sulfate or chromium(III) salts of organic acids, e.g. chromium(III) methanesulfonate, chromium(III) citrate.

In addition, it is possible to use complexing agents such as polycarboxylic acids, hydroxycarboxylic acids, hydroxypolycarboxylic acids, aminocarboxylic acids or hydroxyphosphonic acids. Examples of possible carboxylic acids are oxalic acid, malonic acid, succinic acid, glutaric acid, adipic acid, pimelic acid, suberic acid, azelaic acid, sebacic acid, maleic acid, phthalic acid, terephthalic acid, tartaric acid, citric acid, malic acid, ascorbic acid, ethylenedinitrilotetraacetic acid, tetrahydrofuran-2-carboxylic acid, maleic acid, ethylenediaminetetra-acetic acid, diethylenediaminepentaacetic acid, nitrilotriacetic acid, lactic acid, adipic acid, 4-aminohippuric acid, 4-aminobenzoic acid, 5-aminoisophthalic acid, L-aspartic acid, L-glutamine, L-glutamic acid, alanine, beta-alanine, L-arginine, L-aspartame, L-alanine, N,N-bis(2-hydroxyethyl)glycine, L-cysteine, L-cystine, glutathione, glycine, glycylglycine, L-histidine, L-hydroxyproline, L-isoleucine, L-leucine, L-lysine, L-methionine, L-ornithine, L-phenylalanine, L-proline, L-serine, L-tyrosine, L-tryptophan, L-threonine, L-valine, N-[tris(hydroxymethyl)methyl]glycine, L-citrulline, N-acetyl-L-cysteine, N-(2-acetamindo)iminodiacetic acid, 1,2-cyclohexeylenedinitrilotetraacetic acid, D(+)-biotine, L-norleucine, 5-aminolaevulic acid, DL-methionine, 3-aminobenzoic acid, 6-aminohexanoic acid, acetylenedicarboxylic acid, pyridine-2,3-dicarboxylic acid, (−)-cinchonic acid, 4-amino-2-hydroxybenzoic acid, pyridine-2,6-dicarboxylic acid, pyridine-2-carboxylic acid, pyrazine-2,3-dicarboxylic acid, pyrazine-2-carboxylic acid, pyridine-4-carboxylic acid, 3,5-dihydroxybenzoic acid, 2,4-dihydroxybenzoic acid, sebacic acid, benzene-1,3,5-tricarboxylic acid, furan-2-carboxylic acid, methylenesuccinic acid, DL-mandelic acid, DL-alpha-aminophenylacetic acid, DL-tropic acid, 2,2′-thiodiacetic acid, 3,3′-thiodipropionic acid, 3-(2-furyl)acrylic acid, piperidine-4-carboxylic acid, 4-guanidinobenzoic acid, L-homoserine, trans-propene-1,2,3-tricarboxylic acid, (R)-(−)-citramalic acid, (3-hydroxyphenyl)acetic acid, 4-hydroxyquinoline-2-carboxylic acid, N-acetyl-L-glutamic acid, N-acetyl-DL-valine, 4-aminohippuric acid, 2,6-dihydroxybenzoic acid, 4-(dimethylamino)benzoic acid, glucuronic acid, citrazinic acid, indole-3-carboxylic acid, indole-5-carboxylic acid, butane-1,2,3,4-tetracarboxylic acid, DL-leucine, 2,2-bis(hydroxymethyl)propionic acid, quinoline-2,4-dicarboxylic acid, 2-aminopyridine-3-carboxylic acid, 5-amino-2-hydroxybenzoic acid, anthranilic acid, benzene-1,2,4-tricarboxylic acid, 3,5-diaminobenzoic acid, 4,8-dihydroxyquinoline-2-carboxylic acid, 3,3-dimethylglutaric acid, trans,trans-2,4-hexadienic acid, 3-hydroxybutyric acid, o-hydroxyhippuric acid, (4-hydroxyphenyl)acetic acid, imidazole-4-acrylic acid, indole-2-carboxylic acid, indole-3-propionic acid, mercaptosuccinic acid, 3-oxoglutaric acid, pyridine-2,4-dicarboxylic acid, pyridine-3,5-dicarboxylic acid, 2-methylalanine, 2-sulfobenzoic acid, pyridine-2,5-dicarboxylic acid, gluconic acid, 4-aminobenzoic acid, (−)-shikimic acid, quinaldic acid, 5-hydroxyisophthalic acid, pyrazole-3,5-dicarboxylic acid, pyridine-3,4-dicarboxylic acid, 1,2-diaminopropanetetraacetic acid, 2-pyridylacetic acid, D-norvaline, 2-methylglutaric acid, 2,3-dibromo-succinic acid, 3-methylglutaric acid, (2-hydroxy-phenyl)acetic acid, 3,4-dihydroxybenzoic acid, diglycolic acid, propane-1,2,3-tricarboxylic acid, 2,3-dimethylaminopropionic acid, 2,5-dihydroxybenzoic acid, 2-hydroxyisobutyric acid, phenylsuccinic acid, N-phenylglycine, 1-aminocyclohexanecarboxylic acid, sarcosine, tropic acid, azelaic acid, pyromucic acid and mucic acid. In addition to the acids, it is also possible to use all anhydrides, salts, nitriles and other compounds which can function as source of the carboxylic acids in the acid medium. Examples of chiral compounds are not restricted to the configuration indicated; it is also possible to use diastereomers, enantiomers or racemates of the compounds indicated.

This listing of possible complexing agents merely gives examples of suitable compounds but does not restrict the group of substances which can be used according to the invention to the substances mentioned. The concentration of the complexing agents in the treatment solutions can be in the range from 0.05 g/l to the solubility limit of the complexing agents.

Furthermore, the treatment solutions can also contain one or more surface-active substances such as oxo alcohol ethoxylates (e.g. Lugalvan ON110, BASF), fatty alcohol ethoxylates (e.g. Ethylan CPG 660, Julius Hoesch GmbH), or surfactants having fluorinated radicals (e.g. Novec FC-4432, 3M) and from 0.01 g/l to 10 g/l of a further metal ion or metalloid ion such as Sc, Y, Ti, Zr, Mo, W, Mn, Fe, Co, Ni, Zn, B, Al, Si, P.

### EXAMPLES

### General Experimental Method

An aqueous treatment solution containing 3.0 g/l of Cr³⁺ (from chromium(III) chloride hexahydrate), 2 g/l of Co²⁺ (from cobalt sulfate heptahydrate) and 8 g/l of PO₄³⁻ (from orthophosphoric acid) and 2.5 g/l of Fe²⁺ (from iron(III) sulfate heptahydrate) and also a compound according to the invention or nitrate as per the comparative example in Table 1 is made up. The treatment solution is brought to a pH of 1.6 using nitric acid/sodium hydroxide. A sheet of low-alloy steel is coated with 10 μm of zinc in an alkaline zinc-plating process (Protolux 3000, Atotech Deutschland GmbH). The sheet is activated in 0.3% strength by weight nitric acid for 10 s, rinsed three times with demineralized water and dipped into the above-described treatment solution for 60 s. The solution is stirred during this procedure. After taking out the metal sheet, the latter is rinsed three times with demineralized water and dried at 80° C. in a convection oven for 10 minutes. The black sheet shows first signs of zinc corrosion after 6 hours in the neutral salt spray test in accordance with DIN EN ISO 9227. A metal sheet produced in an analogous way is treated by means of an organic-silicate-containing sealing composition (e.g. Corrosil Plus 501, Atotech Deutschland GmbH) and dried at 80° C. in a convection oven for 10 minutes. The metal sheet is tested in the neutral salt spray test in accordance with DIN EN ISO 9227. The time in hours until the first signs of zinc corrosion can be discerned is reported in Table 1.

TABLE 1
Experiments on conversion layers

| Experiment | Compound according | Amount/ | Corrosion |
|---|---|---|---|
| No. | to the invention | g/l | test |
| 1 | nitrobenzenesulfonic | 9.3 | 96 h |
| | acid (sodium salt) | | |
| 2 | pyridine N-oxide | 10.0 | 96 h |
| 3 | benzoquinone | 6.0 | 96 h |
| 4 | sodium nitrate | 3.5 | 48 h |
| (comparison) | | | |

1. A process for producing essentially chromium(VI)-free conversion layers on zinc or zinc alloy layers, comprising
immersing a surface comprising a zinc or zinc alloy layer in an aqueous treatment solution containing Cr³⁺ ions and further comprising at least one organic compound selected from: 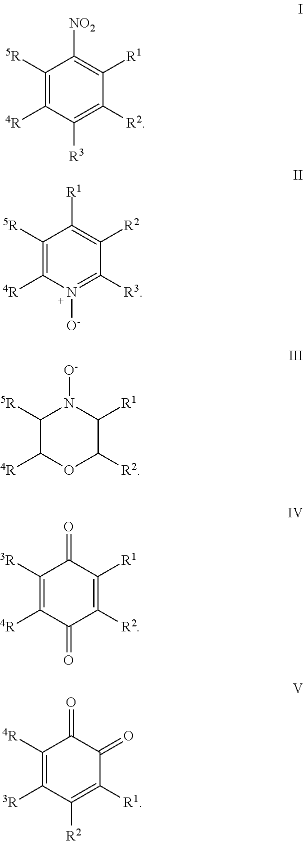
where R¹ to R⁵ are each, independently of one another,
a) a hydrogen atom or an alkyl group which has from 1 to 10 carbon atoms and may be linear or branched or
b) an —NR₂, —NO₂, —COOR, —OR, —SO₃R group where R═—H or an alkyl group which has from 1 to 5 carbon atoms and may be linear or branched,
with the proviso that from 0 to 2 radicals R¹ to R⁵ are selected from group b).

2. The process according to claim 1, characterized in that the organic compound is selected from the group consisting of 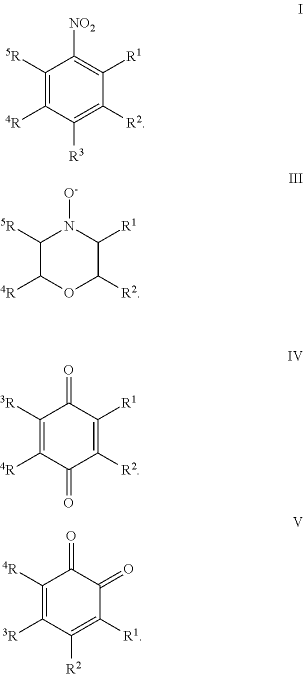
where R¹ to R⁵ are each, independently of one another,
a) a hydrogen atom or an alkyl group which has from 1 to 10 carbon atoms and may be linear or branched or
b) an —NR₂, —NO₂, —COOR, —OR, —SO₃R group where R═—H or an alkyl group which has from 1 to 5 carbon atoms and may be linear or branched,
with the proviso that from 0 to 2 radicals R¹ to R⁵ are selected from group b).

3. The process according to claim 1, characterized in that the organic compound is selected from the group consisting of 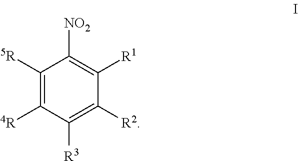
where R¹ to R⁵ are each, independently of one another,
a) a hydrogen atom or an alkyl group which has from 1 to 10 carbon atoms and may be linear or branched or
b) an —NR₂, —NO₂, —COOR, —OR, —SO₃R group where R═—H or an alkyl group which has from 1 to 5 carbon atoms and may be linear or branched,
with the proviso that from 0 to 2 radicals R¹ to R⁵ are selected from group b).

4. The process according to claim 1, characterized in that the organic compound is selected from the group comprising m-nitrobenzoic acid, 2-hydroxy-5-nitrobenzoic acid, 3,5-dinitro-salicylic acid, 2,4-dinitrophenol, m-nitrobenzene-sulfonic acid, N-methylmorpholine N-oxide, pyridine N-oxide and p-benzoquinone.

5. The process according to claim 1, characterized in that the concentration of the organic compounds I.-V. is in the range from 30 mg/l to 30 g/l of the substance.

6. The process according to claim 1, characterized in that the treatment solution contains from 0.2 g/l to 20 g/l of chromium(III) ions.

7. The process according to claim 1, characterized in that the treatment solution contains at least one anion selected from the group comprising methanesulfonate, sulfate, hydrogensulfate, borate, acidic boric esters, phosphate, hydrogenphosphate, dihydrogenphosphate, chloride, iodide, fluoride, nitrate, hexafluoro-silicate, hexafluorotitanate, tetrafluoroborate, hexafluoroantimonate, hexafluorophosphate, phosphate, hydrogenphosphate, dihydrogenphosphate and anions of esters of phosphoric acid.

8. The process according to claim 1, characterized in that the treatment solution additionally contains at least one metal or metalloid selected from the group comprising Sc, Y, Ti, Zr, Mo, W, Mn, Fe, Co, Ni, Zn, B, Al, Si, P in a concentration of from 0.01 to 10 g/l.

9. The process according to claim 1, characterized in that the treatment solution contains from 0.05 g/l to 20 g/l of at least one complexing agent selected from the group comprising polycarboxylic acids, hydroxycarboxylic acids, hydroxypolycarboxylic acids, aminocarboxylic acids and hydroxyphosphonic acids.

10. The process according to claim 1, characterized in that the treatment solution has a pH in the range from pH 0.1 to pH 7.

11. A process for the treatment of a zinc or zinc alloy surface,
characterized in that the surface to be treated is dipped into a treatment solution comprising
at least one source of Cr³⁺ ions and
at least one organic compound selected from the group consisting of 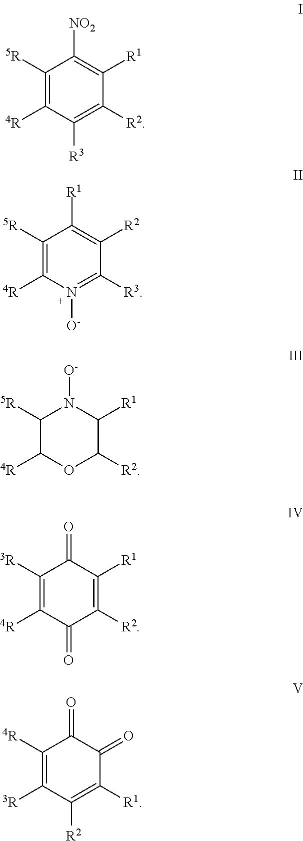
where R¹ to R⁵ are each, independently of one another,
a) a hydrogen atom or an alkyl group which has from 1 to 10 carbon atoms and may be linear or branched or
b) an —NR₂, —NO₂, —COOR, —OR, —SO₃R group where R═—H or an alkyl group which has from 1 to 5 carbon atoms and may be linear or branched,
with the proviso that from 0 to 2 radicals R¹ to R⁵ are selected from group b).

12. The process according to claim 11, characterized in that the organic compound is selected from the group consisting of 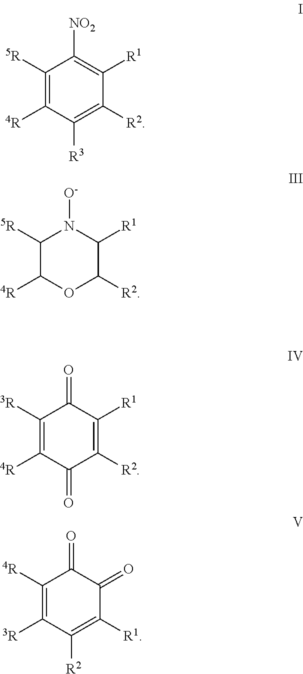
where R¹ to R⁵ are each, independently of one another,
a) a hydrogen atom or an alkyl group which has from 1 to 10 carbon atoms and may be linear or branched or
b) an —NR₂, —NO₂, —COOR, —OR, —SO₃R group where R═—H or an alkyl group which has from 1 to 5 carbon atoms and may be linear or branched,
with the proviso that from 0 to 2 radicals R¹ to R⁵ are selected from group b).

13. The process according to claim 11, characterized in that the organic compound is selected from the group consisting of 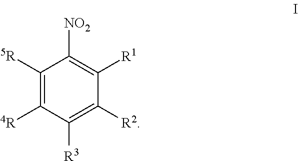
where R¹ to R⁵ are each, independently of one another,
a) a hydrogen atom or an alkyl group which has from 1 to 10 carbon atoms and may be linear or branched or
b) an —NR₂, —NO₂, —COOR, —OR, —SO₃R group where R═—H or an alkyl group which has from 1 to 5 carbon atoms and may be linear or branched,
with the proviso that from 0 to 2 radicals R¹ to R⁵ are selected from group b).

14. The process according to claim 11, characterized in that the organic compound is selected from the group comprising m-nitrobenzoic acid, 2-hydroxy-5-nitrobenzoic acid, 3,5-dinitro-salicylic acid, 2,4-dinitrophenol, m-nitrobenzene-sulfonic acid, N-methylmorpholine N-oxide, pyridine N-oxide and p-benzoquinone.

15. The process according to claim 11, characterized in that the concentration of the organic compounds I.-V. is in the range from 30 mg/l to 30 g/l of the substance.

16. The process according to claim 11, characterized in that the treatment solution contains from 0.2 g/l to 20 g/l of chromium(III) ions.

17. The process according to claim 11, characterized in that the treatment solution contains at least one anion selected from the group comprising methanesulfonate, sulfate, hydrogensulfate, borate, acidic boric esters, phosphate, hydrogenphosphate, dihydrogenphosphate, chloride, iodide, fluoride, nitrate, hexafluoro-silicate, hexafluorotitanate, tetrafluoroborate, hexafluoroantimonate, hexafluorophosphate, phosphate, hydrogenphosphate, dihydrogenphosphate and anions of esters of phosphoric acid.

18. The process according to claim 11, characterized in that the treatment solution additionally contains at least one metal or metalloid selected from the group comprising Sc, Y, Ti, Zr, Mo, W, Mn, Fe, Co, Ni, Zn, B, Al, Si, P in a concentration of from 0.01 to 10 g/1.

19. The process according to claim 11, characterized in that the treatment solution contains from 0.05 g/l to 20 g/l of at least one complexing agent selected from the group comprising polycarboxylic acids, hydroxycarboxylic acids, hydroxypolycarboxylic acids, aminocarboxylic acids and hydroxyphosphonic acids.

20. The process according to claim 11, characterized in that the treatment solution has a pH in the range from pH 0.1 to pH 7.

21. The process according to claim 11, characterized in that the treatment solution has a temperature in the range from 10° C. to 90° C.
